(19) United States
(12) Patent Application Publication
(10) Pub. No.: US 2014/0264089 A1
(43) Pub. Date: Sep. 18, 2014

(54) APPARATUS AND METHOD FOR GENERATING EXTREME ULTRA VIOLET RADIATION

(71) Applicant: Samsung Electronics Co., Ltd., Suwon-si (KR)

(72) Inventors: In-Sung Kim, Seongnam-si (KR); Ho-Yeon Kim, Seoul (KR); Ho-Chul Kim, Seoul (KR); Seung-Koo Lee, Seoul (KR); Jin-Ho Jeon, Seoul (KR)

(73) Assignee: Samsung Electronics Co., Ltd., Suwon-si (KR)

(21) Appl. No.: 14/097,644

(22) Filed: Dec. 5, 2013

(30) Foreign Application Priority Data
Mar. 14, 2013 (KR) 1020130027476

(51) Int. Cl. H05G 2/00

(52) U.S. Cl. CPC H05G 2/008
USPC 250/504 R

(57) ABSTRACT

An apparatus and method for generating extreme ultra violet EUV radiation includes a light source providing light to a laser medium to generate a first laser, a droplet generator to provide a droplet to reflect the first laser to one end of the laser medium, a laser generator positioned at the opposite end of the laser medium from that of the droplet and a second laser to expand the droplet or not and to thereby control the conversion efficiency and dose of the EUV generation apparatus.

### CROSS-REFERENCE TO RELATED APPLICATION

This application claims priority from Korean Patent Application No. 10-2013-0027476 filed on Mar. 14, 2013 in the Korean Intellectual Property Office, and all the benefits accruing therefrom under 35 U.S.C. 119, the contents of which in its entirety are herein incorporated by reference.

### BACKGROUND

1. Field

Inventive concepts relate to an apparatus and method for generating extreme ultra violet radiation.

2. Related Art

In order to achieve micro-fabrication (that is, further-reduced geometries) of semiconductor devices, a lithography process using extreme ultra violet radiation has been proposed. In such a lithographic process, light, also referred to herein as a light beam, may be projected on a silicon substrate through a mask having a circuit pattern, thereby forming an electronic circuit by exposing a resist material. The minimal processing dimensions of the circuit formed by optical lithography are generally dependent on the wavelength of the light source. Accordingly, in order to produce circuitry having smaller geometries, a shorter wavelength of light may be used in a light source used for a photo-lithographic process.

Extreme ultraviolet (EUV), that is, light having a wavelength of from approximately Ito 100 nm, may be employed for reduced-geometry circuits. Because light within this range has high absorptivity with respect to many materials and, therefore, a transmissive optical system such as a lens may not be used, a reflective optical system may be used. Additionally, it is very difficult to develop an optical system that operates in the EUV light range, and only a limited sub-range of EUV wavelengths exhibits practicable reflection characteristics.

### SUMMARY

Exemplary embodiments in accordance with principles of inventive concepts provide an apparatus for generating extreme ultra violet (EUV) radiation, which controls a dose using a pulse counting method while improving conversion efficiency (CE) using a prepulse technology. An apparatus for generating extreme ultra violet radiation includes: a light source to provide light; a laser medium to receive the light and generating first laser; a droplet generator to provide a droplet to reflect the first laser to one side of the laser medium; a laser generator positioned at the opposite side of the laser medium from that of the droplet to provide a second laser of a different frequency from that of the first laser; and a dichroic mirror positioned between the laser medium and the laser generator to reflect the first laser and transmit the second laser.

An apparatus for generating extreme ultra violet radiation further includes a controller to control the laser generator.

An apparatus for generating extreme ultra violet radiation further includes a feedback device to feed back information obtained by calculating the energy of the generated extreme ultra violet radiation to the controller.

An apparatus for generating extreme ultra violet radiation further includes a power amplifier to amplify the first or second laser.

An apparatus for generating extreme ultra violet radiation includes: a light source to provide light; a laser medium to receive the light and generate a first laser; a droplet generator to provide a droplet to reflect the first laser to one side of the laser medium; a first reflecting mirror positioned at the opposite side of the laser medium from that of the droplet to reflect the first laser; and a laser generator to provide a second laser along a different path from a path in which the first reflecting mirror reflects the first laser.

An apparatus for generating extreme ultra violet radiation further includes a second reflecting mirror to reflect the second laser.

An apparatus for generating extreme ultra violet radiation further includes a position adjusting unit to adjust a position of the second reflecting mirror.

An apparatus for generating extreme ultra violet radiation further includes a first feedback device to feed back information obtained by calculating the energy of the generated extreme ultra violet radiation to the position adjusting unit.

An apparatus for generating extreme ultra violet radiation further includes a controller to control the laser generator.

An apparatus for generating extreme ultra violet radiation further includes a second feedback device to feed back information obtained by calculating the energy of the generated extreme ultra violet radiation to the controller.

An apparatus for generating extreme ultra violet radiation further includes a power amplifier to amplify the first or second laser.

A method for generating extreme ultra violet radiation includes: providing light to a laser medium and generating a first laser; providing a second laser; allowing the second laser to reach a droplet to increase a surface area of a droplet; allowing the first laser to reach the droplet and reflecting light from the first laser through the laser medium; allowing the first reflected light to reach a mirror positioned at the opposite end of the laser medium from the droplet and passing light from the second laser through the mirror; and allowing light from the second laser to reach the droplet.

A method for generating extreme ultra violet radiation further including, feeding back information obtained by calculating the energy of the generated extreme ultra violet radiation.

A method for generating extreme ultra violet radiation further including, providing of the second laser includes controlling the second laser based on the calculated energy information.

A method for generating extreme ultra violet radiation further including, amplifying the first or second laser.

A method for generating extreme ultra violet radiation includes: forming a first laser using an optical resonator; irradiating an EUV droplet with the first laser to generate EUV light; and controlling a second laser to alter the conversion efficiency of the EUV light generation.

A method for generating extreme ultra violet radiation further including, wherein the forming of a first laser includes forming a CO₂ resonator.

A method for generating extreme ultra violet radiation further including, wherein the second laser generates light of a different wavelength from that of the first laser.

A method for generating extreme ultra violet radiation further including, wherein the second laser is formed in-line with the first.

A method for generating extreme ultra violet radiation further including, wherein the lasers are formed in a pre-pulse no-master-oscillator configuration.

### BRIEF DESCRIPTION OF THE DRAWINGS

The above and other features and advantages of the present inventive concept will become more apparent by describing in detail preferred embodiments thereof with reference to the attached drawings in which:

FIGS. 1 and 2 illustrate a portion of a conventional apparatus for generating extreme ultra violet radiation based on a master oscillator power amplifier (MOPA);

FIGS. 3 and 4 illustrate a situation in which laser hits a target material in the conventional MOPA based EUV radiation generating apparatus;

FIG. 5 illustrates a portion of an EUV radiation generating apparatus in accordance with principles of inventive concepts;

FIG. 6 illustrates a portion of an EUV radiation generating apparatus according to another embodiment in accordance with principles of inventive concepts;

FIG. 7 illustrates dose control in the conventional MOPA based EUV radiation generating apparatus;

FIG. 8 illustrates dose control in the EUV radiation generating apparatus shown in FIG. 6;

FIG. 9 illustrates a portion of an EUV radiation generating apparatus according to still another embodiment in accordance with principles of inventive concepts;

FIG. 10 illustrates a portion of an EUV radiation generating apparatus according to still another embodiment in accordance with principles of inventive concepts;

FIG. 11 illustrates a portion of an EUV radiation generating apparatus according to still another embodiment in accordance with principles of inventive concepts;

FIG. 12 illustrates a portion of an EUV radiation generating apparatus according to still another embodiment in accordance with principles of inventive concepts;

FIG. 13 is a flowchart sequentially illustrating an extreme ultra violet radiation method in accordance with principles of inventive concepts;

FIG. 14 is a block diagram of an electronic system including a semiconductor device fabricated using an EUV radiation generating apparatus according to some embodiments in accordance with principles of inventive concepts; and

FIGS. 15 and 16 illustrate an exemplary semiconductor system to which semiconductor devices fabricated using a EUV radiation generating apparatus according to some embodiments in accordance with principles of inventive concepts can be employed.

### DESCRIPTION

Various exemplary embodiments will be described more fully hereinafter with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough, and will convey the scope of exemplary embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, regions, layers and/or sections, these elements, components, regions, layers and/or sections should not be limited by these terms. These terms are only used to distinguish one element, component, region, layer or section from another region, layer or section. In this manner, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. In this manner, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. In this manner, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with principles of inventive concepts will be explained in detail with reference to the accompanying drawings.

FIGS. 1 and 2 illustrate a portion of a conventional apparatus for generating extreme ultra violet radiation based on a master oscillator power amplifier (MOPA), and FIGS. 3 and 4 illustrate a process whereby a laser hits a target material (tin, for example) in the conventional MOPA based EUV radiation generating apparatus to generate EUV.

Referring to FIG. 1, the conventional MOPA based EUV radiation generating apparatus includes a main pulse generator 10, a prepulse generator 20, reflecting mirrors 30 to 35, and power amplifiers (PA1, PA2 and PA3) 40, 41 and 42.

The main pulse generator 10 generates a first laser L1. The first laser L1 is irradiated into a position X2, and when a droplet D reaches a position X2, EUV radiation is generated by interaction between the first laser L1 and the droplet D and, therefore, the droplet may be referred to herein as an EUV droplet.

Typically, the droplet D is a droplet of tin (Sn) and the laser heats the droplet of tin to the point of evaporation and super-heating to critical temperature thereby forming a plasma. Ions created by interaction of the laser and tin droplet emit photons, which are collected by a highly-reflective mirror. The mirror redirects the light and focuses it through an aperture and into a lithography system.

The prepulse generator 20 generates a second laser L2. The second laser L2 is irradiated into the position X1, and when the droplet D reaches the position X1 before reaching the position X2, the second laser L2 increases a surface area of the droplet D. That is to say, before the first laser L1 and the droplet D interact with each other as the first laser L1 generated from the main pulse generator 10 reaches the position X2, the surface area of the droplet D is increased, thereby increasing the conversion efficiency (CE) of the UV generating apparatus. The conversion efficiency CE is the ratio between CO₂ laser input power and EUV output power.

The reflecting mirrors 30 to 35 serve to establish a path for the second laser L2 generated from the prepulse generator 20 to be irradiated into the position X1.

The power amplifiers 40, 41 and 42 amplify the first laser L1 or the second laser L2.

Another conventional MOPA based EUV radiation generating apparatus will now be described with reference to FIG. 2. The following description will focus on differences between the conventional MOPA based EUV radiation generating apparatuses shown in FIGS. 1 and 2.

Referring to FIG. 2, the prepulse generator 20 generates the second laser L2 through an independent optical path. That is to say, the second laser L2 generated from the prepulse generator 20 is irradiated into the position X1 through the reflecting mirrors 30 and 31. Here, the second laser L2 is amplified by the power amplifier 43. On the other hand, the first laser L1 is amplified by the power amplifiers 40, 41 and 42.

A process whereby a laser hits a target material in the conventional MOPA based EUV radiation generating apparatus and parameters of the conventional MOPA based EUV radiation generating apparatus will be described with reference to FIGS. 3 and 4.

Referring to FIG. 3, when the droplet D moves in a direction X and reaches the position X1, the second laser L2 generated from the prepulse generator 20 hits the droplet D. Next, when the droplet D continues to move and reaches position X2, the first laser L1 generated from the main pulse generator 10 hits the droplet D. During a time dT in which the droplet moves from the position X1 to the position X2, the droplet D may be moved by an amount dZ in a direction Z which coincides with the direction the first laser L1 or the second laser L2 travels. As a result, the excursion dZ should be taken into consideration when irradiating the droplet D.

Referring to FIG. 4, when the droplet D moves from the position X1 to the position X2, the droplet D may also be displaced in the Y direction, which is perpendicular to the direction X in which the droplet D travels. The excursion dY should also be taken into consideration when irradiating droplet D.

As described above, when the first laser L1 and the second laser L2 are irradiated, at least 4 parameters of time (T), energy (E), directions Y and Z should be taken into consideration, and the parameters should be controlled in a loop close state. At least 8 parameters in total should be taken into consideration when generating EUV in this manner. Even if a relative time T of the first laser L1 to the second laser L2, and Y and Z are let to be constants, at least 5 parameters should be taken into consideration.

In addition, the energy of EUV radiation may vary by a gas flow in the vessel, a change in the position of the droplet D due to vibration of a droplet generator, a change in the pulse energy of the first and second lasers L1 and L2. Accordingly, it is difficult to control the dose of EUV radiation employing a conventional process and apparatus such as described.

Exemplary embodiments of apparatuses and methods for generating EUV radiation according to principles of inventive concepts relate to controlling the dose of EUV delivered (to a lithography system, for example) using a pulse counting method. Additionally, in accordance with principles of inventive concepts, conversion efficiency may be improved using a prepulse technique. As described in the background section above, in order to generate EUV radiation using laser-produced plasma (LPP), a master oscillator power amplifier system may be used, with a main pulse and a prepulse generated using a seed laser. After the prepulse is irradiated into a target material (a tin droplet, for example), EUV radiation is emitted using plasma generated by irradiating the main pulse into the target material. The method in which the prepulse is irradiated into the target material and the main pulse is then irradiated into the target material may be affected by a number of parameters and, as a result of variations in parameter values, the stability of EUV radiation generated may be unstable.

On the other hand, in exemplary embodiments of EUV radiation generating apparatuses in accordance with principles of inventive concepts, the number and variability of parameters affecting EUV emission are reduced by a resonator structure using a prepulse. Additionally, the dose of EUV radiation may be controlled using the prepulse and pulse counting in accordance with principles of inventive concepts.

Hereinafter, an exemplary embodiment of an apparatus and method for generating EUV radiation in accordance with principles of inventive concepts will be described with reference to the accompanying drawings.

FIG. 5 illustrates an exemplary embodiment of a portion of a EUV radiation generating apparatus in accordance with principles of inventive concepts. The EUV radiation generating apparatus 1 includes a light source 100, a laser medium 200, a droplet generator 300, a laser generator 400, and a dichroic mirror 500. In accordance with principles of inventive concepts, droplet D and dichroic mirror 500 are positioned at opposite ends of laser medium 200, thereby forming a resonator. Such a resonator structure may be referred to herein as a prepulse no master oscillator (prepulse-NOMO) structure and it eliminates variable parameters that might contribute to instability in conventional EUV light sources such as the MOPA-based EUV generators previously described.

The light source 100 provides light. The light source 100 may be spaced a predetermined distance apart from the laser medium 200, and the laser medium 200 may provide energy for generating the first laser L1. A power supply unit for supplying power to the light source 100 may be connected to the light source 100. The light source 100 may include, for example, a lamp. The light source 100 may include another laser, for example, to supply energy to the laser medium 200.

In exemplary embodiments in accordance with principles of inventive concepts, the laser medium 200 receives light provided by light source 100 and generates the first laser L1. That is, the light source 100 performs optical pumping such whereby a higher density of electrons at a high energy level are included in the laser medium 200 than electrons at a low energy level. This state may be referred to as, “density inversion.” Additionally, light that leaks out of laser medium 200 is reflected back into the medium 200 by a vessel provided outside the laser medium. As stimulated emission is caused in a state in which the density of the electrons of the laser medium 200 is inverted by optical pumping, light having the same direction and phase as incident light is generated and amplified. That is to say, the amount of light is increased, perhaps by a multiple of two, by the stimulated emission. The increased light is reflected between the droplet D and the dichroic mirror 500 to pass through laser medium 200. And reflected light passing through the medium 200 causes additional stimulated emission(s), thereby further increasing the amount of light emitted.

As previously described, droplet D and dichroic mirror 500, positioned at opposite ends of the laser medium 200 form a resonator structure by which first laser L1 is generated. In exemplary embodiments in accordance with principles of inventive concepts, first laser L1 may be, for example, a CO₂ laser having a high pulse rate of 50 kHz or greater and oscillating with a wavelength of 9.3 μm or 10.6 μm. Because first laser L1 is generated with the resonator structure, it may be more stable than a conventional MOPA based EUV radiation generating apparatus because variable parameters that cause instability in a conventional pulse generator are not an issue with a pulse generator employing a resonator structure in accordance with principles of inventive concepts.

The droplet generator 300 provides droplet D which serves as a reflecting mirror reflects the first laser L1 to one side of the laser medium 200. Therefore, the greater the surface area of the droplet D, the more light is reflected back into the medium 200, and the greater the energy of EUV radiation is generated by interaction between the droplet D and the first laser L1. In exemplary embodiments in accordance with principles of inventive concepts, droplet D may include at least one of tin (Sn), lithium (Li), and xenon (Xe), for example. Droplet D may be a gas such as tin (Sn), lithium (Li), or xenon (Xe), or a cluster of gases, for example and droplet D may be located in a vacuum environment. Such a vacuum may be in the range of 10⁻⁵ to 10⁻⁴ Torr, for example.

Laser generator 400 is positioned at the opposite side of the laser medium 200 from droplet D and provides a second laser L2. In exemplary embodiments in accordance with principles of inventive concepts, second laser L2 may be, for example, a Nd:YAG laser oscillating with a wavelength of 0.5 μm or 1 μm. The laser generator 400 may target droplet D with laser L2 in order to increase the surface area of droplet D and to thereby increase the amount of light reflected back into laser medium 200 and, concomitantly, to increase the conversion efficiency of the EUV source in accordance with principles of inventive concepts. The conversion efficiency CE may be improved increased significantly (for example, by two or more times) by thus increasing the surface area of droplet D.

In accordance with principles of inventive concepts, dichroic minor 500, which is positioned between the laser medium 200 and the laser generator 400, reflects the first laser L1 while transmitting the second laser L2. In exemplary embodiments in accordance with principles of inventive concepts dichroic minor 500 may be a reflecting minor having thin film layers made of multiple materials having different refractive indices. As a result, light of a first wavelength, or range of wavelengths, may be reflected while light of a second wavelength, or range of wavelengths may be transmitted by the multiple materials having different refractive indices. Additionally, loss due to light absorption is relatively small, and the range of wavelengths of selectively reflected light can be varied according to the thickness or structure of material used in dichroic mirror 500. Because, in exemplary embodiments in accordance with principles of inventive concepts, first laser L1 and the second laser L2 have different wavelengths, the first laser L1 may be reflected by dichroic mirror 500, while the second laser L2 is transmitted.

As previously indicated, in exemplary embodiments in accordance with principles of inventive concepts, second laser L2, provided by laser generator 400, is transmitted through the dichroic mirror 500 to reach the droplet D and increase the surface area of the droplet D, thereby increasing the CE of a EUV generator in accordance with principles of inventive concepts. That is, first laser L1 generated from the laser medium 200 is reflected between the dichroic mirror 500 and the droplet D to then generate EUV radiation. As the first laser L1 is repeatedly reflected multiple times, it interacts with the droplet D, which, due to interaction with second laser L2, has an increased surface area, and, as a result, the energy of EUV radiation generated is increased.

FIG. 6 illustrates a portion of an exemplary embodiment of an apparatus for generating extreme ultra violet radiation in accordance with principles of inventive concepts. FIG. 7 illustrates dose control in a conventional MOPA based EUV radiation generating apparatus, such as has been described in the discussion related to FIGS. 1-4. FIG. 8 illustrates dose control in exemplary embodiments of extreme ultra violet radiation generating apparatuses in accordance with principles of inventive concepts, such as that shown in FIG. 6. For the sake of brevity and convenient explanation, the following description will focus on differences between the EUV radiation generating apparatuses according to the present embodiments and those associated with the discussion of FIG. 5.

Referring to FIGS. 6 and 8, EUV radiation generating apparatus 2 may further include a controller 600 and a feedback device 700, not shown in the EUV radiation generating apparatus 1 in accordance with principles of inventive concepts, as illustrated in FIG. 5.

In exemplary embodiments in accordance with principles of inventive concepts, the pulse energy of generated EUV light may be controlled by controlling the conversion efficiency CE of the EUV source. And the CE of the EUV source may controlled by the controller 600 controlling the on/off state of the laser generator 400. With the laser generator 400 in the off state, the second laser L2 is off, and, as a result, laser L2 does not reach droplet D and the surface area of droplet D is not increased, as it would be if laser L2 were on. Although laser L1 will still operate, with droplet D reflecting energy back into laser medium 200, droplet D will not reflect as much light as it would if second laser L2 were on; the efficiency of EUV generation is reduced when laser L2 is off. In this manner the pulse energy of EUV radiation may be controlled by altering the conversion efficiency of the EUV generator, which, in turn, is controlled by controlling laser generator 400

In exemplary embodiments in accordance with principles of inventive concepts, even when laser generator 400 is off, EUV radiation may be generated, as previously described, by interaction between the first laser L1 and the droplet D and a resonator structure in accordance with principles of inventive concepts. As illustrated in FIG. 8, the pulse energy of the EUV radiation generated in an exemplary embodiment in accordance with principles of inventive concepts when the laser generator 400 is off is approximately 50% of the pulse energy when the laser generator is on. The ratio of EUV pulse energy generated with laser generator 400 off to that when the laser generator 400 is on may, however, vary. In such a manner, exemplary embodiments of EUV radiation generating apparatuses in accordance with principles of inventive concepts can achieve dose control more efficiently than a conventional MOPA based EUV radiation generating apparatus, the pulses of which are illustrated in FIG. 7.

In exemplary embodiments in accordance with principles of inventive concepts, feedback device 700 feeds back information obtained by calculating the energy of the generated EUV radiation to the controller 600. Accordingly, the laser generator 400 is controlled by the controller 600, thereby controlling the dose of EUV radiation.

FIG. 9 illustrates a portion of another exemplary embodiment of an apparatus for generating extreme ultra violet radiation in accordance with principles of inventive concepts. For the sake of clarity and convenience of explanation, the following description will focus on differences between the EUV radiation generating apparatuses according to this embodiment and previously described embodiments in accordance with principles of inventive concepts. In this exemplary embodiment, the EUV radiation generating apparatus 3 includes power amplifiers (PA1, PA2 and PA3) 800, 810 and 820, in addition to the EUV radiation generating apparatus 1 previously described. In accordance with principles of inventive concepts, power amplifiers 800, 810 and 820 may amplify a first laser L1 and/or a second laser L2. In FIG. 9, the power amplifiers 800, 810 and 820 are configured to amplify both the first laser L1 and the second laser L2. Additionally the three power amplifiers 800, 810, and 820 may be serially arranged, as in, in FIG. 9 for example. Each of the power amplifiers 800, 810 and 820 may be supplied with gas discharge electrical energy from an individual pulse power system so as to be initially charged by a single high-voltage power supply (or by each individual high-output power supply), for example.

FIG. 10 illustrates a portion of an apparatus for generating extreme ultra violet radiation according to another exemplary embodiment in accordance with principles of inventive concepts. For the sake of clarity and convenience of explanation, the following description will focus on differences between the EUV radiation generating apparatuses according to the present and previous embodiments in accordance with principles of inventive concepts. The EUV radiation generating apparatus 4 includes a light source 100, a laser medium 200, a droplet generator 300, a laser generator 400, a first reflecting mirror 900, and second reflecting mirrors 1000 and 1001.

The light source 100 provides light. The light source 100 may be spaced a predetermined distance apart from the laser medium 200, and the laser medium 200 may provide energy for generating the first laser L1. A power supply unit for supplying power to the light source 100 may be connected to the light source 100. The light source 100 may include, for example, a lamp. The light source 100 may include another laser, for example, to supply energy to the laser medium 200.

In exemplary embodiments in accordance with principles of inventive concepts, the laser medium 200 receives light provided by light source 100 and generates the first laser L1. That is, the light source 100 performs optical pumping such whereby a higher density of electrons at a high energy level are included in the laser medium 200 than electrons at a low energy level. This state may be referred to as, “density inversion.” Additionally, light that leaks out of laser medium 200 is reflected back into the medium 200 by a vessel provided outside the laser medium. As stimulated emission is caused in a state in which the density of the electrons of the laser medium 200 is inverted by optical pumping, light having the same direction and phase as incident light is generated and amplified. That is to say, the amount of light is increased, perhaps by a multiple of two, by the stimulated emission. The increased light is reflected between the droplet D and the first reflecting mirror 900 to pass through laser medium 200. And reflected light passing through the medium 200 causes additional stimulated emission(s), thereby further increasing the amount of light emitted.

As previously described, droplet D and reflecting mirror 900, positioned at opposite ends of the laser medium 200 form a resonator structure by which first laser L1 is generated. In exemplary embodiments in accordance with principles of inventive concepts, first laser L1 may be, for example, a CO₂ laser having a high pulse rate of 50 kHz or greater and oscillating with a wavelength of 9.3 μm or 10.6 μm. Because first laser L1 is generated with the resonator structure, it may be more stable than a conventional MOPA based EUV radiation generating apparatus because variable parameters that cause instability in a conventional pulse generator are not an issue with a pulse generator employing a resonator structure in accordance with principles of inventive concepts.

The droplet generator 300 provides droplet D which serves as a reflecting mirror reflects the first laser L1 to one side of the laser medium 200. Therefore, the greater the surface area of the droplet D, the more light is reflected back into the medium 200, and the greater the energy of EUV radiation is generated by interaction between the droplet D and the first laser L1. In exemplary embodiments in accordance with principles of inventive concepts, droplet D may include at least one of tin (Sn), lithium (Li), and xenon (Xe), for example. Droplet D may be a gas such as tin (Sn), lithium (Li), or xenon (Xe), or a cluster of gases, for example and droplet D may be located in a vacuum environment. Such a vacuum may be in the range of 10⁻⁵ to 10⁻⁴ Torr, for example.

In exemplary embodiments in accordance with principles of inventive concepts laser generator 400 provides a second laser L2 in a different path from that in which the first reflecting mirror 900 reflects the first laser L1 second laser L2 and the optical path in which the second laser L2 travels may be adjusted by the second reflecting mirrors 1000 and 1001. Although, two second reflecting mirrors 1000 and 1001 are illustrated in the exemplary embodiment of FIG. 10, inventive concepts are not limited thereto.

In exemplary embodiments in accordance with principles of inventive concepts, second laser L2 may be, for example, a Nd:YAG laser oscillating with a wavelength of 0.5 μm or 1 μm. The laser generator 400 may target droplet D with laser L2 in order to increase the surface area of droplet D and to thereby increase the amount of light reflected back into laser medium 200 and, concomitantly, to increase the conversion efficiency of the EUV source in accordance with principles of inventive concepts. The conversion efficiency CE may be improved increased significantly (for example, by two or more times) by thus increasing the surface area of droplet D.

The first reflecting mirror 900 is positioned at the opposite side of the laser medium 200 and reflects the first laser L1. The EUV radiation is generated from the first laser L1 generated from the laser medium 200 while the first laser L1 is reflected between the first reflecting mirror 900 and the droplet D. As the first laser L1 is repeatedly reflected multiple times, it interacts with the droplet D having the increased surface area, thereby increasing the pulse energy of EUV radiation generated.

FIG. 11 illustrates a portion of an apparatus for generating extreme ultra violet radiation according to another exemplary embodiment in accordance with principles of inventive concepts. For the sake of clarity and convenience of explanation, the following description will focus on differences between the EUV radiation generating apparatuses according to this and previously described exemplary embodiments. EUV radiation generating apparatus 5 further includes a position adjusting unit 1100, a first feedback device 710, a controller 600, and a second feedback device 720, compared to the exemplary embodiment of a EUV radiation generating apparatus 1 in accordance with principles of inventive concepts.

The position adjusting unit 1100 adjusts positions of the second reflecting mirrors 1000 and 1001 to allow the second laser L2 to either reach or not to reach the droplet D. If the second laser L2 does not reach the droplet D, the surface area of the droplet D is not increased and EUV generation efficiency is lowered, thereby reducing the conversion efficiency CE. In such a manner, the pulse energy of EUV radiation generated can be controlled using a difference in the conversion efficiency CE. Even when the second laser L2 does not reach the droplet D, EUV radiation may be generated by interaction between the first laser L1 and the droplet D by a resonator structure. In this manner, an exemplary embodiment of an EUV radiation generating apparatus in accordance with principles of inventive concepts can achieve EUV dose control more efficiently than a conventional MOPA based EUV radiation generating apparatus.

The first feedback device 710 feeds back information obtained by calculating the sensed energy of the generated EUV radiation to the position adjusting unit 1100 which controls the second laser L2 to reach or not to reach the droplet D to control the dose of EUV radiation.

In exemplary embodiments in accordance with principles of inventive concepts, the pulse energy of generated EUV light may be controlled by controlling the conversion efficiency CE of the EUV source. And the CE of the EUV source may controlled by the controller 600 controlling the on/off state of the laser generator 400. With the laser generator 400 in the off state, the second laser L2 is off, and, as a result, laser L2 does not reach droplet D and the surface area of droplet D is not increased, as it would be if laser L2 were on. Although laser L1 will still operate, with droplet D reflecting energy back into laser medium 200, droplet D will not reflect as much light as it would if second laser L2 were on; the efficiency of EUV generation is reduced when laser L2 is off. In this manner the pulse energy of EUV radiation may be controlled by altering the conversion efficiency of the EUV generator, which, in turn, is controlled by controlling laser generator 400

In exemplary embodiments in accordance with principles of inventive concepts, even when laser generator 400 is off, EUV radiation may be generated, as previously described, by interaction between the first laser L1 and the droplet D and a resonator structure in accordance with principles of inventive concepts. As illustrated in FIG. 8, the pulse energy of the EUV radiation generated in an exemplary embodiment in accordance with principles of inventive concepts when the laser generator 400 is off is approximately 50% of the pulse energy when the laser generator is on. The ratio of EUV pulse energy generated with laser generator 400 off to that when the laser generator 400 is on may, however, vary. In such a manner, exemplary embodiments of EUV radiation generating apparatuses in accordance with principles of inventive concepts can achieve dose control more efficiently than a conventional MOPA based EUV radiation generating apparatus, the pulses of which are illustrated in FIG. 7.

The second feedback device 720 feeds back information obtained by calculating the sensed energy of the generated EUV radiation to the controller 600. Accordingly, the laser generator 400 is controlled by the controller 600, thereby controlling the dose of EUV radiation.

FIG. 12 illustrates a portion of an apparatus for generating extreme ultra violet radiation according to another exemplary embodiment in accordance with principles of inventive concepts. For the sake of clarity and convenience of explanation, the following description will focus on differences between this exemplary embodiment of an EUV radiation generating apparatus and those previously described.

Referring to FIG. 12, the EUV radiation generating apparatus 6 may further include power amplifiers (PA1, PA2, PA3 and PA4) 800, 810, 820 and 830, compared to the exemplary embodiment of an EUV radiation generating apparatus 1 in accordance with principles of inventive concepts.

The power amplifiers 800, 810 and 820 amplify a first laser L1, and the power amplifier 830 amplifies a second laser L2. In FIG. 12, three power amplifiers 800, 810 and 820 are serially arranged, but aspects of inventive concepts are not limited thereto. Each of the power amplifiers 800, 810 and 820 may be supplied with gas discharge electrical energy from an individual pulse power system so as to be initially charged by a single high-voltage power supply (or by each individual high-output power supply), for example.

Hereinafter, EUV radiation methods according to some embodiments of the present inventive concept will be described.

A method of EUV radiation generation in accordance with principles of inventive concepts will be described in reference to the flow chart of FIG. 13.

Light is provided a laser medium to generate a first laser (S1000). In exemplary embodiments in accordance with principles of inventive concepts, the laser medium receives light provided by light source and generates the first laser. That is, the light source performs optical pumping whereby a higher density of electrons at a high energy level are included in the laser medium than electrons at a low energy level. Additionally, light that leaks out of laser medium is reflected back into the medium 200 by a vessel provided outside the laser medium. As stimulated emission is caused in a state in which the density of the electrons of the laser medium is inverted by optical pumping, light having the same direction and phase as incident light is generated and amplified. That is to say, the amount of light is increased, perhaps by a multiple of two, by the stimulated emission. The increased light is reflected between a droplet and a mirror to pass through the laser medium, and reflected light passing through the medium causes additional stimulated emission(s), thereby further increasing the amount of light emitted.

Next, a second laser is provided through a laser generator (S1100). The second laser may be, for example, a CO₂ laser having a high pulse of 50 kHz or greater and oscillating with a wavelength of 9.3 μm or 10.6 μm.

Next, the second laser is allowed to reach the droplet to increase a surface area of the droplet (S1200). The laser generator may direct the second laser toward the droplet to increase the surface area of the droplet. The conversion efficiency CE can be improved by two times or greater by increasing the surface area of the droplet.

Next, the first laser is allowed to reach the droplet to reflect first reflected light through the droplet (S1300). Next, the first reflected light is allowed to reach the mirror to reflect second reflected light through the mirror (S1400). The mirror may be a dichroic mirror or a reflecting mirror, for example. Next, the second reflected light is allowed to reach the droplet (S1500), thereby generating EUV radiation by interaction between the second reflected light and the droplet. Although not shown in FIG. 13, information obtained by calculating the energy of the generated EUV radiation may be fed back to the laser generator, and the laser generator may control generation of the second laser L2 according to the obtained information, and may thereby increase or decrease the conversion efficiency in order to control EUV dosage. In addition, the first laser or the second laser may be amplified by a power amplifier.

FIG. 14 is a block diagram of an electronic system including a semiconductor device fabricated using a EUV radiation generating apparatus according to exemplary embodiments in accordance with principles of inventive concepts. The electronic system 2100 may include a controller 2110, an input/output device (I/O) 2120, a memory device 2130, an interface 2140 and a bus 2150. The controller 2110, the I/O 2120, the memory device 2130, and/or the interface 2140 may be connected to each other through the bus 2150. The bus 2150 corresponds to a path through which data moves.

The controller 2110 may include at least one of a microprocessor, a digital signal processor, a microcontroller, and logic elements capable of functions similar to those of these elements. The I/O 2120 may include a keypad, a keyboard, a display device, and so on. The memory device 2130 may store data and/or codes. The interface 2140 may perform functions of transmitting data to a communication network or receiving data from the communication network. The interface 2140 may be wired or wireless. For example, the interface 2140 may include an antenna or a wired/wireless transceiver, and so on.

Although not shown, the electronic system 2100 may further include high-speed DRAM and/or SRAM as the operating memory for improving the operation of the controller 2110. Fin type FETs according to embodiments of the present inventive concept may be incorporated into the memory device 2130 or provided as part of the I/O 2120.

The electronic system 2100 may be applied to a personal digital assistant (PDA), a portable computer, a web tablet, a wireless phone, a mobile phone, a digital music player, a memory card, or any type of electronic device capable of transmitting and/or receiving information in a wireless environment.

FIGS. 15 and 16 illustrate an exemplary semiconductor system to which semiconductor devices fabricated using a EUV radiation generating apparatus according to some embodiments of the present inventive concept can be employed.

FIG. 15 illustrates an example in which a semiconductor device in accordance with principles of inventive concepts is applied to a tablet PC, and FIG. 16 illustrates an example in which a semiconductor device in accordance with principles of inventive concepts is applied to a notebook computer. At least one of the semiconductor devices fabricated using a EUV radiation generating apparatus according to some embodiments of the present inventive concept can be employed to a tablet PC, a notebook computer, and the like. It is obvious to one skilled in the art that the semiconductor devices fabricated using a EUV radiation generating apparatus according to some embodiments of the present inventive concept may also be applied to other IC devices not illustrated herein.

Although inventive concepts have been particularly shown and described with reference to exemplary embodiments thereof, it will be understood by those of ordinary skill in the art that various changes in form and details may be made therein without departing from the spirit and scope of inventive concepts as defined by the following claims. The present embodiments are to be considered in all respects as illustrative and not restrictive, reference being made to the appended claims rather than the foregoing description to indicate the scope of inventive concepts.

What is claimed is:

1. An apparatus for generating extreme ultra violet radiation, the apparatus comprising:
a light source to provide light;
a laser medium to receive the light and generating first laser;
a droplet generator to provide a droplet to reflect the first laser to one side of the laser medium;
a laser generator positioned at the opposite side of the laser medium from that of the droplet to provide a second laser of a different frequency from that of the first laser; and
a dichroic mirror positioned between the laser medium and the laser generator to reflect the first laser and transmit the second laser.

2. The apparatus of claim 1, further comprising a controller to control the laser generator.

3. The apparatus of claim 2, further comprising a feedback device to feed back information obtained by calculating the energy of the generated extreme ultra violet radiation to the controller.

4. The apparatus of claim 1, further comprising a power amplifier to amplify the first or second laser.

5. An apparatus for generating extreme ultra violet radiation, the apparatus comprising:
a light source to provide light;
a laser medium to receive the light and generate a first laser;
a droplet generator to provide a droplet to reflect the first laser to one side of the laser medium;
a first reflecting mirror positioned at the opposite side of the laser medium from that of the droplet to reflect the first laser; and
a laser generator to provide a second laser along a different path from a path in which the first reflecting mirror reflects the first laser.

6. The apparatus of claim 5, further comprising a second reflecting mirror to reflect the second laser.

7. The apparatus of claim 6, further comprising a position adjusting unit to adjust a position of the second reflecting mirror.

8. The apparatus of claim 7, further comprising a first feedback device to feed back information obtained by calculating the energy of the generated extreme ultra violet radiation to the position adjusting unit.

9. The apparatus of claim 5, further comprising a controller to control the laser generator.

10. The apparatus of claim 9, further comprising a second feedback device to feed back information obtained by calculating the energy of the generated extreme ultra violet radiation to the controller.

11. The apparatus of claim 5, further comprising a power amplifier to amplify the first or second laser.

12. A method for generating extreme ultra violet radiation, the method comprising:
providing light to a laser medium and generating a first laser;
providing a second laser;
allowing the second laser to reach a droplet to increase a surface area of a droplet;
allowing the first laser to reach the droplet and reflecting a first reflected light from the droplet;
allowing the first reflected light to reach a mirror positioned at the opposite end of the laser medium from the droplet and reflecting a second reflected light from the mirror; and
allowing the second reflected light to reach the droplet.

13. The method of claim 12, further comprising feeding back information obtained by calculating the energy of the generated extreme ultra violet radiation.

14. The method of claim 13, wherein providing of the second laser includes controlling the second laser based on the calculated energy information.

15. The method of claim 12, further comprising amplifying the first or second laser.

16. A method of generating EUV light, comprising:
forming a first laser using an optical resonator;
irradiating an EUV droplet with the first laser to generate EUV light;
and
controlling a second laser to alter the conversion efficiency of the EUV light generation.

17. The method of claim 16, wherein the forming of a first laser includes forming a CO₂ resonator.

18. The method of claim 16, wherein the second laser generates light of a different wavelength from that of the first laser.

19. The method of claim 16, wherein the second laser is formed in-line with the first.

20. The method of claim 16, wherein the lasers are formed in a pre-pulse no-master-oscillator configuration.
